(19) United States
(12) Patent Application Publication
(10) Pub. No.: US 2003/0110809 A1
(43) Pub. Date: Jun. 19, 2003

(54) Characterization of optical preforms

(75) Inventors: Michael W. Linder, Corning, NY (US); Joseph F. Ellison, Penfield, NY (US)

Correspondence Address: WALL MARJAMA & BILINSKI, 101 SOUTH SALINA STREET, SUITE 400, SYRACUSE, NY, 13202, US

(73) Assignee: Corning, Inc.

(21) Appl. No.: 10/055,183

(22) Filed: Oct. 26, 2001

(51) Int. Cl. C03B 37/023; G06F 17/00

(52) U.S. Cl. 65/385; 707/104.1

(57) ABSTRACT

The present invention is directed to a method for characterizing an optical preform. To achieve this, the present invention provides a three-dimensional map of the refractive-index distribution within a boule or an optical preform. The three-dimensional map of the refractive-index distribution allows device manufacturers to better predict the performance of the optical device. The three-dimensional map also allows device manufacturers to determine the best orientation of the preform during device extraction.

### BACKGROUND OF THE INVENTION

1. Field of the Invention

The present invention relates generally to the manufacture of optical preforms, and particularly to manufacturing optical preforms in accordance with specified refractive index characteristics.

2. Technical Background

There is a direct correlation between the linewidth of semiconductor devices and the resolution of the photolithographic systems that are used to produce such devices. Typically, a photolithographic system includes a projection optical system that employs lenses to project an image of a circuit onto a semiconductor substrate. One of the key parameters of these lenses is the homogeneity of the refractive index of the lens element. As such, customers often specify the refractive index homogeneity of the optical preform that will be used to make a particular lens. During manufacture, the optical preform is extracted from a larger optical member known as a boule.

In one approach, the standard boule test (SBT) is performed to evaluate the refractive index properties of a fused silica boule. In this method, the boule under test must be made transparent to the interferometer laser that is used to measure the boule's index of refraction variation. The oil-on-flats (OOF) method is one way of providing transparency. In this method, the boule is sandwiched between two polished flats, and index-matching fluid is disposed in the boule-flat interface. Another way of performing the SBT is to use the polished homogeneity method or the Schwider method. Unfortunately, the SBT has significant drawbacks.

Using the Cartesian coordinate system as a reference, each boule has a three-dimensional refractive index distribution n(x, y, z). The SBT provides index variations only in the x-y plane, e.g., the SBT provides a two-dimensional refractive index distribution n(x, y). The x, y values provided by the two-dimensional SBT map represent an averaging throughout the thickness (z-axis) of the boule. However, averaging along the z-axis is inappropriate, since lens manufacturers typically manufacture their devices from an optical preform cut from a boule. Further, the lenses typically have a high numerical aperture. As a result, device manufacturers are unable to predict with sufficient accuracy the performance of the device being fabricated using the information provided by the SBT. Furthermore, manufacturers cannot determine which way the preform should be orientated during the cutting of the lens to achieve optimum performance.

What is needed is a way to provide a conclusive three-dimensional map of the refractive-index distribution of an optical preform or boule. A three-dimensional map of the refractive-index distribution would allow device manufacturers to better predict the performance of the optical device. A three-dimensional map of the refractive-index distribution would also allow device manufacturers to determine the best orientation of the preform during device extraction. For example, if a lens is to be cut out in a meniscus, plano-convex, or plano-concave shape, knowledge of the three-dimensional refractive index variation would enable the lens maker to orient the preform such that the preform portions having the highest inhomogeneity are cut away.

### SUMMARY OF THE INVENTION

The present invention provides a three-dimensional map of the refractive-index distribution of an optical preform or boule. The three-dimensional map of the refractive-index distribution in accordance with the present invention allows device manufacturers to better predict the performance of the optical device. The three-dimensional map in accordance with the present invention also allows device manufacturers to determine the best orientation of the preform during device extraction.

One aspect of the present invention is a computer-readable medium having a data structure stored thereon. The data structure includes data representing a characteristic of an optical member. The data structure includes at least one field containing information corresponding to a three-dimensional map of the optical member. The map includes a plurality of refractive index measurements taken at a plurality of interior locations within the optical member.

In another aspect, the present invention includes a computer-readable medium having computer-executable instructions for performing a method for characterizing an optical member. The method includes the step of providing information corresponding to a plurality of refractive index measurements taken at a plurality of interior locations within the optical member. The information is converted into a three-dimensional map of the optical member. The three-dimensional map includes a plurality of refractive index values distributed throughout the interior of the optical member.

In another aspect, the present invention includes a method for making an optical device having specified refractive-index characteristics. The optical device is derived from a boule that is dimensionally characterized by a radial axis and an axis normal to the radial axis. The method includes extracting a radial strip from the boule. The strip has a cross-sectional area in a plane formed by the radial axis and the axis normal to the radial axis. A plurality of refractive index measurements are taken of the strip at a plurality of locations in the cross-sectional area. The plurality of refractive index measurements are converted into a three-dimensional map of the boule. The three-dimensional map includes a plurality of calculated refractive index values distributed throughout the interior of the boule. An optical blank is extracted from the boule. The optical blank is taken from a portion of the boule having calculated refractive index values that substantially match the specified refractive-index characteristics.

In another aspect, the present invention includes a method for processing a request for an optical device having predetermined refractive-index characteristics. The method includes the step of taking a plurality of refractive index measurements at a plurality of interior locations within a boule. The plurality of refractive index measurements are converted into a three-dimensional map of the boule. The three-dimensional map includes a plurality of refractive index values distributed throughout the interior of the optical member. Information corresponding to the three-dimensional map is provided.

In another aspect, the present invention includes a method for making an optical device having predetermined refractive-index characteristics. The optical device is derived from a boule that is dimensionally characterized by a radial axis and an axis normal to the radial axis. The method includes placing the boule in a measurement tool. Index-matching fluid is disposed in an interface volume formed between the boule and the measurement tool. The index-matching fluid has a predetermined refractive index substantially identical to the refractive index of the measurement tool. At least one set of refractive index measurements is taken of the boule by directing light into the boule via the measurement tool. The light is directed in a direction normal to a plane formed by the radial axis and the axis normal to the radial axis. The set of refractive index measurements is converted into a three-dimensional map of the boule. The three-dimensional map includes a plurality of calculated refractive index values distributed throughout the interior of the boule. An optical blank is extracted from the boule. The optical blank is taken from a portion of the boule having calculated refractive index values that substantially match the predetermined refractive-index characteristics.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a perspective view of a boule and a radial strip used in a method for characterizing an optical preform in accordance with a first embodiment of the present invention;

FIG. 2 is a block diagram of an apparatus for characterizing an optical preform in accordance with the first embodiment of the present invention;

FIG. 3 is a chart showing the measured z-axis profile versus the calculated z-axis profile of the radial strip depicted in FIG. 1;

FIG. 4 is a block diagram of showing the extraction of optical preforms from the boule shown in FIG. 1;

FIG. 5 is a block diagram of an apparatus for characterizing an optical preform in accordance with a second embodiment of the present invention; and

FIG. 6 is a block diagram of an alternate apparatus for characterizing an optical preform in accordance with the second embodiment of the present invention.

### DETAILED DESCRIPTION

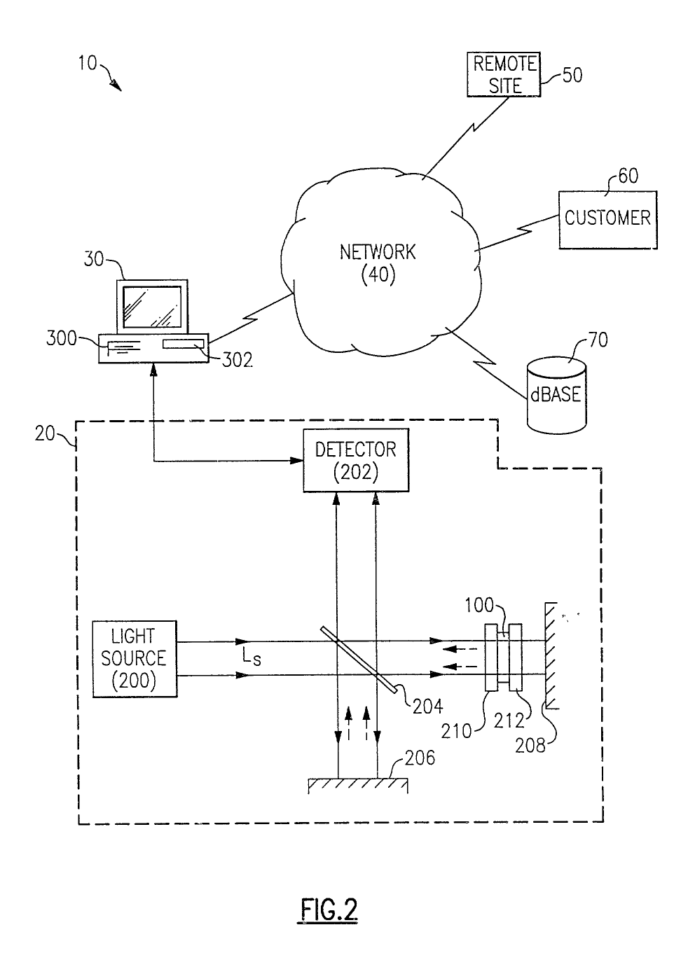

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the apparatus for performing the method for characterizing an optical preform is shown in FIG. 2, and is designated generally throughout by reference numeral 10.

In accordance with the invention, the present invention for a method for characterizing an optical preform includes a computer-readable medium having a data structure stored thereon. The data structure includes data representing a characteristic of an optical member. The data structure includes at least one field containing information corresponding to a three-dimensional map of the optical member. The map includes a plurality of refractive index measurements taken at a plurality of interior locations within the optical member. Thus, the present invention provides a three-dimensional map of the refractive-index distribution of boule and/or an optical preform. The three-dimensional map of the refractive-index distribution in accordance with the present invention allows device manufacturers to better predict the performance of the optical device. The three-dimensional map in accordance with the present invention also allows device manufacturers to determine the best orientation of the preform during device extraction. The three-dimensional index data is used to evaluate boule quality attributes as well as to evaluate the best locations to extract parts based on customer's specifications. This allows for pre-qualification of parts prior to extraction. This saves time, material, and hence, money.

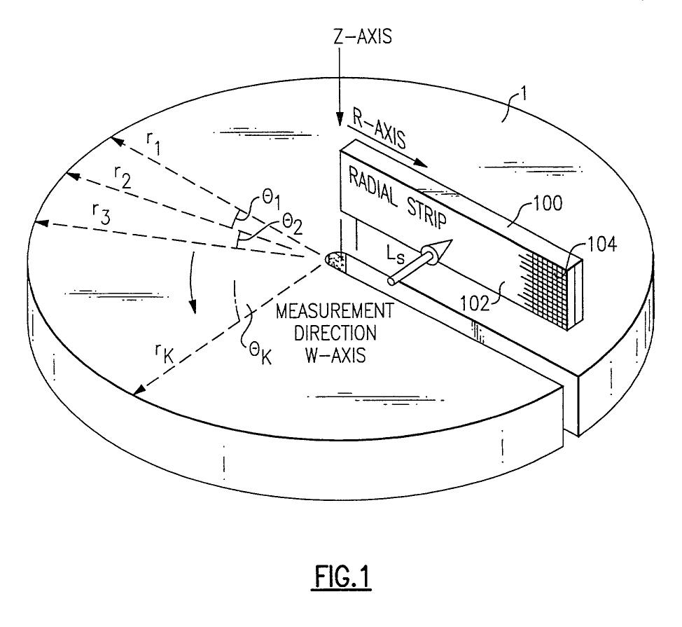

As embodied herein, and depicted in FIG. 1, a perspective view of boule 1 and radial strip 100 used in a method for characterizing an optical preform in accordance with a first embodiment of the present invention is disclosed. The first step in the method requires the extraction of radial strip 100 from boule 1. The extracted radial strip 100 has a thickness on the order of 50-60 mm. Radial strip 100 has a measurement surface 102 co-planar with the cross-sectional area of strip 100. The cross-sectional area is defined by the radial axis (r-axis) and the z-axis, which is normal to the radial axis. Surface 102 is prepared for measurement by performing optically finishing surface 102, using methods such as grinding and polishing. Radial strip 100 is interferometrically measured in the w-axis direction, as shown in FIG. 1. An array of pixel areas 104 are measured, each providing a refractive-index value. The spacing of the pixel areas depends on the density of the CCD camera in the interferometer (see FIG. 2). In one embodiment, the spacing is approximately 0.6 mm/pixel. This data is used to calculate a three-dimensional map of the refractive-index variation of the boule. One key aspect of the present invention is the realization that boule 1 is substantially rotationally symmetric. Thus, the refractive index values in the two dimensional map of surface 102 can be replicated at various radial locations defined by angle θi to thereby convert the two dimensional map of surface 102 into a three-dimensional map of the entire boule.

Those of ordinary skill in the art will recognize that boule 1 may be of any suitable type of rotationally symmetric material, but there is shown by way of example a fused silica boule fabricated using a flame hydrolysis process. Thus, doped fused silica or calcium fluoride may also be used. Typically, fused silica boule 1 has a diameter of about 1.5 meters and a thickness in the range of 12-20 centimeters. In accordance with commercial practice, a plurality of optical blanks are cut from such boules. The optical blanks are used to make optical devices such as lenses and prisms. In one application, the lenses are used in the projection optical systems and the illumination optical systems of photolithographic systems. It will also be apparent to those of ordinary skill in the art that other materials may be used to fabricate boule 1.

As embodied herein, and depicted in FIG. 2, a block diagram of an apparatus 10 for characterizing an optical preform in accordance with the first embodiment of the present invention is disclosed. Apparatus 10 includes phase measuring interferometer 20 coupled to computer 30. Computer 30 is coupled to network 40. Thus, three-dimensional mapping information may be transmitted via network 40 to any remote site 50, customer location 60, or to a data storage location, such as database 70.

Computer 30 may be of any suitable type, but there is shown by way example a personal computer including a Pentium processor. In another embodiment computer 30 is networked to a server via a LAN. Computer 30 includes electronic memory, a hard disk, a floppy disk drive 300, and compact disk device 302. Computer 30 is programmed to store three-dimensional mapping information in the electronic memory, onto the hard disk drive, or onto a floppy disk. The three dimensional mapping information may also be written to a compact disk in device 302. Obviously, a floppy disk or a compact disk having the mapping information stored thereon, may be delivered to a customer via courier, delivery service, or by some other means.

Those of ordinary skill in the art will recognize that network 40 may be of any suitable type, but there is shown by way of example the Internet. Those of ordinary skill in the art will also recognize that computer 30 may transmit three-dimensional mapping information over the public switched telephone network (PSTN) via a modem. Network 40 may also be implemented using a local area network (LAN), a personal area network (PAN), a wireless network, or a packet switched network.

One of ordinary skill in the art will recognize that the present invention may employ many different interferometer configurations that are currently commercially available, but by way of example, interferometer 20 includes a laser light source 200 which is optically coupled to beamsplitter 204. Beamsplitter 204 is optically coupled to radial strip 100, which is coupled to mounting mirror 208. As discussed above, radial strip 100 must be made transparent to laser 200. This is achieved by sandwiching radial strip 100 between polished flats (210, 212) while adding index matching liquid at each surface interface. If transparency is ensured by polishing radial strip 100, the polished homogeneity (PHOM) method or the Schwider method can also be employed as well. Beamsplitter 204 is also coupled to reference mirror 206 and detector 202. Detector 202 includes a CCD camera as explained above.

In operation, laser 200 directs light signal Ls toward beamsplitter 204. The light signal Ls is split into two beams which are directed toward reference mirror 206 and radial strip 100 mounted on mounting mirror 208. Ultimately, both beams are recombined and directed toward detector 202. The recombined light beam creates a fringe pattern which is captured by the CCD camera in detector 202. Both the optical path length and the thickness of radial strip 100 can be determined by evaluating multiple measurements with phase shift of the reference plane 206, by evaluating the number and location of reference fringes between certain interference patterns. After correction of interferometer and surface errors, the variation of the index of refraction for a given measurement is calculated using the formula Δn=(OPL/Th), where OPL is the optical path length difference and Th is the thickness of radial strip 100 at the given measurement location.

Computer 30 is programmed to evaluate the reference fringes and perform the above stated calculation. Computer 30 stores the results for each measurement and creates a two-dimensional mapping of surface 102 (see FIG. 1). As discussed above, one key aspect of the present invention is the realization that a fused silica boule is substantially rotationally symmetric. Thus, computer 30 is programmed to replicate the refractive index values populating the two dimensional map of surface 102 to create a quasi three-dimensional map. The performance of potential parts extracted from boule 1 using the generated three-dimensional map can then be predicted with greater accuracy. The generation of the quasi three-dimensional map is described more thoroughly below.

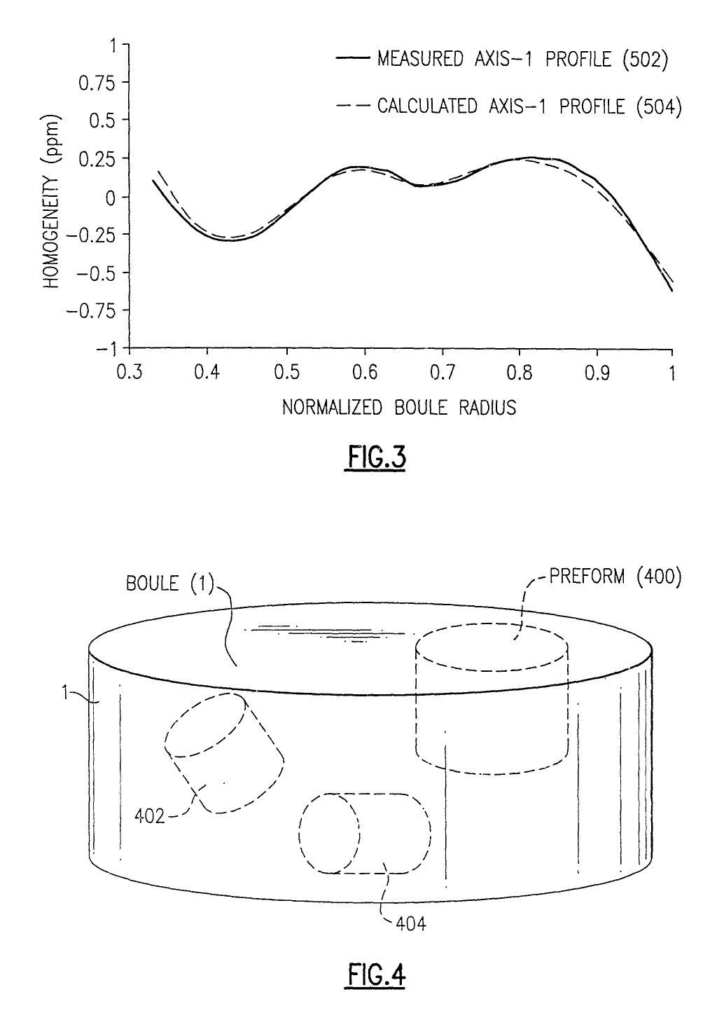

As embodied herein, and depicted in FIG. 3, a chart showing the measured z-axis profile versus the calculated z-axis profile of radial strip 100 depicted in FIG. 1 is disclosed. As illustrated in FIG. 3, the measured z-axis index variation is almost identical (within measurement error) to z-axis variation calculated using the quasi-three-dimensional mapping data. The horizontal axis of the chart in FIG. 4 is the normalized radius, obtained by dividing the radial location by the maximum boule radius. Three dimensional index variation of the boule is calculated using the following equations. First, a radial index value is calculated using the measured w-axis data according to the following equation:

n₁(r)=∫ₓ∫_{y}n_{wxy}(r, x, y)dx dy (1)

where r is the boule radial coordinate, x and y are the locations of the w-axis index data (see FIG. 1), n₁ is the calculated z-axis index value, and n_{w} is the measured w-axis index value. The symmetric z-axis boule rectangular index map is then calculated using the equation:

n₁(r, θ)=[(1−mod(x²+y²)^{0.5})]*n₁ᵢ(r)+[mod(x²+y²)^{0.5}]*n₁ᵢ(r+1) (2)

where x=r cos θ, and y=r sin θ. X and y are the Cartesian coordinates of boule z-axis data, and r and θ are the polar coordinates of boule z-axis data. The boule index map is generated using the w-axis index array of data. To evaluate sub-apertures of the boule for part selection and extraction, portions of the w-axis data are selected and the z-axis profile is generated by placing appropriate limits on the double integration in equation (1) above.

In another salient feature of the present invention, the process described above is further refined by measuring the refractive index of boule 1 in the plane (r, θ). A two-dimensional homogeneity map is created and compared with the calculated values obtained from the quasi three-dimensional map. Subsequently, the differences between the quasi three-dimensional map values in plane (r, θ) and the measured values from the two-dimensional homogeneity map are calculated. The difference values form an inhomogeneity distribution that represents the departure from perfect rotational symmetry. The difference values are homogeneously distributed throughout the thickness of the boule to create a new and improved three-dimensional map of the boule. These additional steps are performed because the boule is not perfectly rotationally symmetric. The above described refinement steps can also be performed on the optical preform after it has been extracted.

As embodied herein, and depicted in FIG. 4, a block diagram of showing the extraction of optical preform 400 from boule 1. As described above, the present invention provides a three-dimensional map of the refractive-index distribution of boule 1 and optical preform 400. Device manufacturer can predict the performance of the optical device with increased certainty because the refractive index variations of the boule 1 and preform 400 are known. Furthermore, the three-dimensional map allows device manufacturers to determine the best orientation of preform (402, 404) during device extraction. When a lens is to be cut out in a meniscus, plano-convex, or plano-concave shape, knowledge of the three-dimensional refractive index variation enables the lens maker to orient the preform such that the preform portions having the highest inhomogeneity are cut away.

As embodied herein, and depicted in FIG. 5 a block diagram of an apparatus for characterizing an optical preform in accordance with a second embodiment of the present invention is disclosed. This embodiment is used to produce a three-dimensional mapping of a master preform that is substantially the same size as the final optical preform. Also, many of the optical preforms used for certain lenses in photolithographic systems are extracted on-axis. Thus, in these circumstances it is not possible to extract a radial strip. Measurement apparatus 600 includes boule, or master preform 1, disposed in measurement tool 604. The interface volume between tool 604 and boule 1 is filled with an index matching fluid that matches the index of tool 604. As described above, the function of the tool and index matching fluid is to make boule 1 transparent to the interferometer laser light. In one embodiment of the present invention tool 604 is fabricated by creating a central bore in a plate of approximately the same size as the master preform. Measurements are taken along the z-axis by taking at least one set of measurements in a cross-sectional plane formed by the preform diameter and the z-axis. Preferably, multiple measurements are obtained by rotating the preform such that multiple cross-sectional planes are measured. The multiple sets of data are then averaged to obtain greater accuracy. There is less need to assume rotational symmetry in calculating the three-dimensional map values when a large number of measurement sets are obtained.

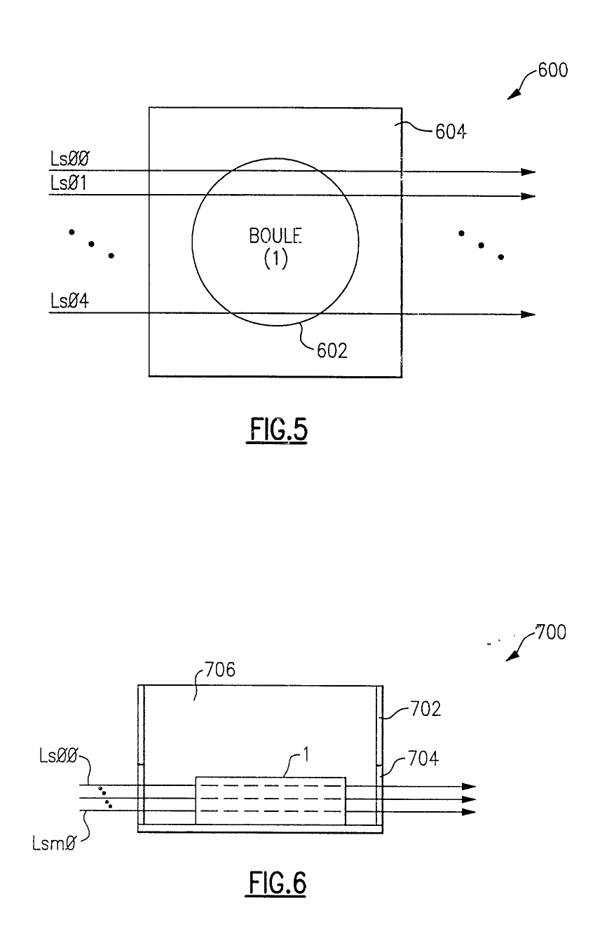

As embodied herein, and depicted in FIG. 6, a block diagram of an alternate apparatus for characterizing an optical preform in accordance with the second embodiment of the present invention is disclosed. Apparatus 700 includes preform 1 immersed in tank 702. The laser light beams of the interferometer are directed through windows 704. Tank 702 is filled with index matching fluid 704. The refractive index of index matching fluid 706 is matched to the refractive index of windows 704 to provide the optical transparency described above.

Those of ordinary skill in the art will recognize that the above described processes can be used in the manufacture of fused silica preforms, fluorite crystals, and ingot processes employing other materials.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A computer-readable medium having stored thereon a data structure, the data structure including data representing a characteristic of an optical member, the data structure comprising:
at least one field containing information corresponding to a three-dimensional map of the optical member, the map including a plurality of refractive index measurements taken at a plurality of interior locations within the optical member.

2. The medium of claim 1, wherein the information includes compressed digital data.

3. The medium of claim 1, wherein the medium includes at least one floppy disk.

4. The medium of claim 1, wherein the medium includes a hard disk.

5. The medium of claim 1, wherein the medium includes a CD-ROM.

6. The medium of claim 1, wherein the medium includes an electronic memory.

7. The medium of claim 1, wherein the medium includes an optical storage medium.

8. The medium of claim 1, wherein the data structure comprises a database.

9. The medium of claim 1, wherein the information includes a plurality of refractive index measurements of a strip extracted from the optical member, the plurality of refractive index measurements taken at a plurality of locations normal to a cross-sectional area formed by a radial axis of the optical member and a axis normal to the radial axis.

10. The medium of claim 1, wherein the at least one field includes a field identifying the optical member.

11. The medium of claim 1, wherein the at least one field includes a homogeneity map of the optical member.

12. A computer-readable medium having computer-executable instructions for performing a method for characterizing an optical member, the method comprising:
providing information corresponding to a plurality of refractive index measurements taken at a plurality of interior locations within the optical member; and
converting the information into a three-dimensional map of the optical member, the three-dimensional map including a plurality of refractive index values distributed throughout the interior of the optical member.

13. The method of claim 12, wherein the step of providing further comprises:
extracting a radial strip from the optical member, the strip having a cross-sectional area in a plane formed by a radial axis of the optical member and an axis normal to the radial axis; and
taking a plurality of refractive index measurements of the strip at a plurality of locations in the cross-sectional area.

14. The method of claim 12, wherein the step of providing includes transmitting the information using e-mail.

15. The method of claim 12, wherein the step of providing includes transmitting the information over the Internet.

16. The method of claim 12, wherein the step of providing includes transmitting the information using a telecommunications network.

17. The method of claim 16, wherein the network is a wireless network.

18. The method of claim 12, wherein the step of providing includes physical delivery of a computer readable medium having stored thereon a data structure, the data structure including at least one field containing information corresponding to a three-dimensional map of the optical member, the map including a plurality of refractive index measurements taken at a plurality of interior locations within the optical member.

19. The method of claim 12, further comprising:
using the map to locate a portion of the optical member having refractive index values corresponding to specified refractive index values; and
extracting the portion to form an optical blank having refractive index values corresponding to specified refractive index values.

20. The method of claim 19, further comprising:
providing the optical blank; and
providing information corresponding to a three-dimensional refractive-index map of the optical blank.

21. The method of claim 20, wherein the step of providing information corresponding to a three-dimensional refractive-index map of the optical blank includes transmitting the information using e-mail.

22. The method of claim 20, wherein the step of providing information corresponding to a three-dimensional refractive-index map of the optical blank includes transmitting the information over the Internet.

23. The method of claim 20, wherein the step of providing information corresponding to a three-dimensional refractive-index map of the optical blank includes transmitting the information using a telecommunications network.

24. The method of claim 23, wherein the network is a wireless network.

25. The method of claim 20, wherein the step of providing information corresponding to a three-dimensional refractive-index map of the optical blank includes physical delivery of a computer readable medium having stored thereon a data structure, the data structure including at least one field containing information corresponding to a three-dimensional map of the optical blank.

26. The method of claim 12, further comprising the step of storing data corresponding to the three dimensional map on a medium.

27. The method of claim 26, wherein the medium includes paper.

28. The method of claim 26, wherein the medium includes an optical storage device.

29. The method of claim 26, wherein the medium includes a floppy disk.

30. The method of claim 26, wherein the medium includes a hard disk.

31. The method of claim 26, wherein the medium includes electronic memory.

32. The method of claim 26, wherein the medium includes a compact disk.

33. A method for making an optical device having specified refractive-index characteristics, the optical device being derived from a boule being dimensionally characterized by a radial axis and an axis normal to the radial axis, the method comprising:
extracting a radial strip from the boule, the strip having a cross-sectional area in a plane formed by the radial axis and the axis normal to the radial axis;
taking a plurality of refractive index measurements of the strip at a plurality of locations in the cross-sectional area; and
converting the plurality of refractive index measurements into a three-dimensional map of the boule, the three-dimensional map including a plurality of calculated refractive index values distributed throughout the interior of the boule.

34. The method of claim 33, further comprising the step of creating a homogeneity map of the optical blank.

35. The method of claim 33, wherein the step of taking is performed using a phase measuring interferometer.

36. The method of claim 33, wherein the step of taking is performed using the PHOM method.

37. The method of claim 33, wherein the step of taking is performed using the index oil method.

38. The method of claim 33, wherein the strip has a width in a range between X-mm and Y-mm.

39. The method of claim 33, wherein the step of extracting includes grinding and polishing each surface of the strip.

40. The method of claim 33, further comprising:
integrating calculated refractive index values along the normal axis at a plurality of points on the radial axis to thereby create a calculated two-dimensional map of calculated two dimensional values;
using the plurality of refractive index measurements to create a measured two dimensional map;
taking the difference of the calculated two dimensional values from corresponding ones of the plurality of refractive index measurements to generate difference values; and
distributing the difference values along the normal axis to create a quasi three dimensional map of refractive index values distributed throughout the boule.

41. The method of claim 33, further comprising:
providing the optical blank; and
providing information corresponding to a three-dimensional refractive-index map of the optical blank.

42. The method of claim 41, wherein the step of providing information corresponding to a three-dimensional refractive-index map of the optical blank includes transmitting the information using e-mail.

43. The method of claim 41, wherein the step of providing information corresponding to a three-dimensional refractive-index map of the optical blank includes transmitting the information over the Internet.

44. The method of claim 41, wherein the step of providing information corresponding to a three-dimensional refractive-index map of the optical blank includes transmitting the information using a telecommunications network.

45. The method of claim 44, wherein the network is a wireless network.

46. The method of claim 41, wherein the step of providing information corresponding to a three-dimensional refractive-index map of the optical blank includes physical delivery of a computer readable medium having stored thereon a data structure, the data structure including at least one field containing information corresponding to a three-dimensional map of the optical blank.

47. The method of claim 33, further comprising the step of storing data corresponding to the three dimensional map on a medium.

48. The method of claim 47, wherein the medium includes paper.

49. The method of claim 47, wherein the medium includes an optical storage device.

50. The method of claim 47, wherein the medium includes a floppy disk.

51. The method of claim 47, wherein the medium includes a hard disk.

52. The method of claim 47, wherein the medium includes electronic memory.

53. The method of claim 33, further comprising the step of extracting an optical blank from the boule, the optical blank being taken from a portion of the boule having calculated refractive index values that substantially match the specified refractive-index characteristics.

54. The method of claim 33, further comprising the step of utilizing the three-dimensional map to identify a portion of the boule that corresponds to a predetermined specification.

55. The method of claim 33, further comprising the step of storing information corresponding to the three-dimension map on a medium.

56. The method of claim 55, wherein the information includes human readable indicia.

57. The method of claim 55, wherein the information includes machine readable indicia.

58. The method of claim 55, wherein the medium is a computer readable medium.

59. The method of claim 55, wherein the medium is an optical medium.

60. The method of claim 55, wherein the medium includes a paper medium.

61. The method of claim 33, further comprising the step of transmitting information corresponding to the three-dimension map over an electronic medium.

62. The method of claim 33, further comprising the step of transmitting information corresponding to the three-dimension map over an optical medium.

63. The method of claim 33, further comprising the step of providing information corresponding to the three-dimension map to a customer.

64. A method for processing a request for an optical device having predetermined refractive-index characteristics, the method comprising:
taking a plurality of refractive index measurements at a plurality of interior locations within a boule;
converting the plurality of refractive index measurements into a three-dimensional map of the boule, the three-dimensional map including a plurality of refractive index values distributed throughout the interior of the optical member; and
providing information corresponding to the three-dimensional map.

65. The method of claim 64, wherein the step of providing information corresponding to a three-dimensional refractive-index map of the optical blank includes transmitting the information using e-mail.

66. The method of claim 64, wherein the step of providing information corresponding to a three-dimensional refractive-index map of the optical blank includes transmitting the information over the Internet.

67. The method of claim 64, wherein the step of providing information corresponding to a three-dimensional refractive-index map of the optical blank includes transmitting the information using a telecommunications network.

68. The method of claim 67, wherein the network is a wireless network.

69. The method of claim 64, wherein the step of providing information corresponding to a three-dimensional refractive-index map of the optical blank includes physical delivery of a computer readable medium having stored thereon a data structure, the data structure including at least one field containing information corresponding to a three-dimensional map of the optical blank.

70. The method of claim 64, further comprising the step of storing data corresponding to the three dimensional map on a medium.

71. The method of claim 64, wherein the medium includes paper.

72. The method of claim 64, wherein the medium includes an optical storage device.

73. The method of claim 64, wherein the medium includes a floppy disk.

74. The method of claim 64, wherein the medium includes a hard disk.

75. The method of claim 64, wherein the medium includes electronic memory.

76. A method for making an optical device having predetermined refractive-index characteristics, the optical device being derived from a boule being dimensionally characterized by a radial axis and an axis normal to the radial axis, the method comprising:
placing the boule in a measurement tool;
disposing index-matching fluid in an interface volume formed between the boule and the measurement tool, the index-matching fluid having a predetermined refractive index substantially identical to the refractive index of the measurement tool;
taking at least one set of refractive index measurements of the boule by directing light into the boule via the measurement tool, the light being directed in a direction normal to a plane formed by the radial axis and the axis normal to the radial axis; and
converting the set of refractive index measurements into a three-dimensional map of the boule, the three-dimensional map including a plurality of calculated refractive index values distributed throughout the interior of the boule.
